(19) United States
(12) Patent Application Publication
(10) Pub. No.: US 2007/0261208 A1
(43) Pub. Date: Nov. 15, 2007

(54) Cushioned handle

(76) Inventor: Alon Ben Ishai, Brooklyn, NY (US)

Correspondence Address: Steven Horowitz;Counselor At Law, Suite 700, 295 Madison Avenue, New York, NY, 10017, US

(21) Appl. No.: 11/435,096

(22) Filed: May 15, 2006

(51) Int. Cl. E05B 1/00

(52) U.S. Cl. 16/436

(57) ABSTRACT

A handle for kitchen implements with a 360 degree air cushion achieves a comfortable yet firm grip. An inner core made of a rigid substance is surrounded by a hard polypropylene sleeve. A tubular air cushion with circular cross-section and containing pressurized air spans approximately 70 percent of the length of the handle and surrounds the sleeve. The inner core has a hanger piece at the end distal from the active tool component. An end ring strengthens this end of the handle. A polyurethane filler fills in the remaining parts of the handle including the outer layer. A unique assembly achieves clean overlap between the parts. The full 360 degree air cushion distributes pressure from a squeezing grip of a user uniformly throughout the tubes without any hard spots.

### FIELD OF THE INVENTION

The field of this invention is handles, and more particularly, handles with air cushions.

### BACKGROUND OF THE INVENTION AND DISCUSSION OF THE PRIOR ART

In the kitchen, a person holding a potato peeler or other kitchen implement, often experiences discomfort by virtue of the fact that the outer surface of the implement is hard, for example, made of metal or wood or very hard plastic, and gripping the outer surface amounts to exerting significant force against a hard surface. This amounts to experiencing a shock against the hand. In addition, food preparation in the kitchen, in particular, often involves repeated motions by the hand. The activities in the kitchen involving food preparation can require hours of peeling, scrambling, turning and other hand tasks. Thus, the discomfort from squeezing the handle of a kitchen implement repeats itself many times over and this results in an experience of fatigue by the user.

Various devices have been designed that provide handles uniquely suited for holding things more comfortably and reduces the shock and fatigue experienced by the user. However, in the course of achieving that result, many devices utilize features that reduce the firmness of the grip and hence alter the degree to which a holder can work efficaciously with the device to prepare the food. For example, when peeling a potato, the holder of the peeler has to press the active tool component, the peeling part, against the potato and maintain the force steadily while moving the hand to peel the potato. The same is true while scrambling eggs in a pan using a scrambler. Even holding pancake to flip it over requires a firm and steady grip. If the handle is too soft, it is harder to hold the handle to cause the active tool component to apply a steady force against the potato or other food item.

Many prior art handles with air cushions have hard spots that add to the discomfort of the handle.

Consequently, it is critical that a handle that provides extra comfort not incorporate features that have the effect of reduces the firmness and effectiveness of the tool, for example by having too many air pockets or providing too soft a material. The comfort should not come at the expense of firmness or reduce the effectiveness of the use of the device.

On the other hand, the benefits of the comfort of the air cushion should be felt as much as possible and therefore the air cushion should be in contact with as much of the user's hand as possible.

Other considerations important to a handle used in kitchen implements include minimizing the amount of dust the handle picks up, the durability of the air cushion, the durability of the device as a whole, the construction of the device to minimize unwanted accumulation of grease or dirt between the handle and the active tool component of the implement and ease of cleaning the device.

Surprisingly, the present invention achieves advantages over the prior art devices in which handles use air cushions because it is specifically designed to improve the handle and provide a maximum amount of cushioning without forfeiting the firmness needed to work effectively with the device that incorporates the handle. In addition, the present invention has many other advantages over the prior art.

### SUMMARY OF THE PRESENT INVENTION

A handle for kitchen implements with a 360 degree air cushion achieves a comfortable yet firm grip. An inner core made of a rigid substance is surrounded by a hard polypropylene sleeve. A tubular air cushion with circular cross-section and containing pressurized air spans approximately 70 percent of the length of the handle and surrounds the sleeve. The inner core has a hanger piece at the end opposite the active tool component. An end ring strengthens the end of the handle. A polyurethane overmold fills in the remaining parts of the handle including the outer layer. A unique assembly achieves clean overlap between the parts including between the handle and the active tool component and between the handle and the hang end at the opposite end of the metal inner core. The full 360 degree air cushion distributes pressure from a squeezing grip of a user uniformly throughout the tubes without any hard spots.

### IMPORTANT OBJECTS AND ADVANTAGES

The following important objects and advantages of the present invention are:

(1) to provide a handle for kitchen peelers and other kitchen implements having an active tool components and a handle component that is comfortable to grasp;

(2) to provide a cushioned handle for kitchen implements that absorbs the shock of the impacting force of a squeezing hand holding the implement and/or applying the implement to food or something else;

(3) to provide such a handle that while exceedingly comfortable also provide maximum firmness so that a user can work effectively with the kitchen implement;

(4) to provide such a handle wherein the user can work comfortably and effectively with the kitchen implement in repeated motions;

(5) to provide a comfortable handle as described wherein the tubular air cushion has no hard spots;

(6) to provide such a handle that uses a closed outer rubber housing;

(7) to provide such a handle as described whose air cushion provides firm and even pressure;

(8) to provide a handle as described whose air cushion is not too soft;

(9) to provide a handle whose air cushion has a circular cross-section for maximum durability;

(10) to provide a handle as described whose air cushion provides even distribution of the squeezing pressure exerted by a user;

(11) to provide such a handle that employs pressurized air to increase firmness;

(12) to provide a handle for kitchen implements that is highly resistant to dust and dirt on its outer surface

(13) to provide a handle that is easy and inexpensive to manufacture;

(14) to provide a handle whose material works better with chemical and natural adhesives than prior art handles;

(15) to provide a handle with an air cushion as described that stays firmer longer than prior art handles;

(16) to provide a handle as described whose effectiveness does not deteriorate over time;

(17) to provide a handle as described whose parts overlap cleanly;

(18) to provide a handle as described which allows less possible buildup of food and grease on its outer surface and into the handle;

(19) to provide a handle as described that is easier to clean that the prior art handles;

(20) to provide a cushioned handle that is versatile enough to be incorporated into a wide variety of kitchen implements;

(21) to provide a cushioned handle for kitchen implements which implements have a very hard inner core, for example made of wood or metal;

(22) to provide a handle with an air cushion in which the user can feel the air cushion on approximately 60 to 80 percent of the handle; and

(23) to provide a handle with an air cushion in which the user can feel the air cushion on approximately 60 to 80 percent of the length of the handle.

### BRIEF DESCRIPTION OF THE DRAWINGS

FIG. 1 is a perspective view of the handle of the present invention having a circular cross-section and forming part of a peeler; and

FIG. 2 is a vertical cross-sectional view of the handle of FIG. 1.

### DETAILED DESCRIPTION OF THE PREFERRED EMBODIMENT

The apparatus of the present invention will now be illustrated by reference to the accompanying drawings. The handle of the present invention has been assigned reference numeral 10. Other elements have been assigned the reference numerals referred to below.

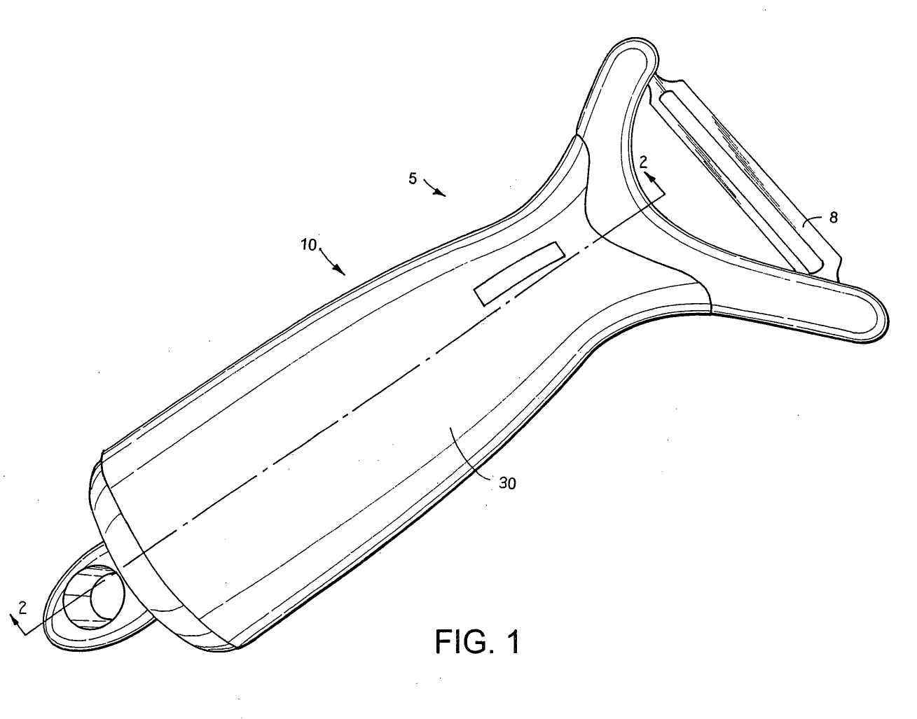

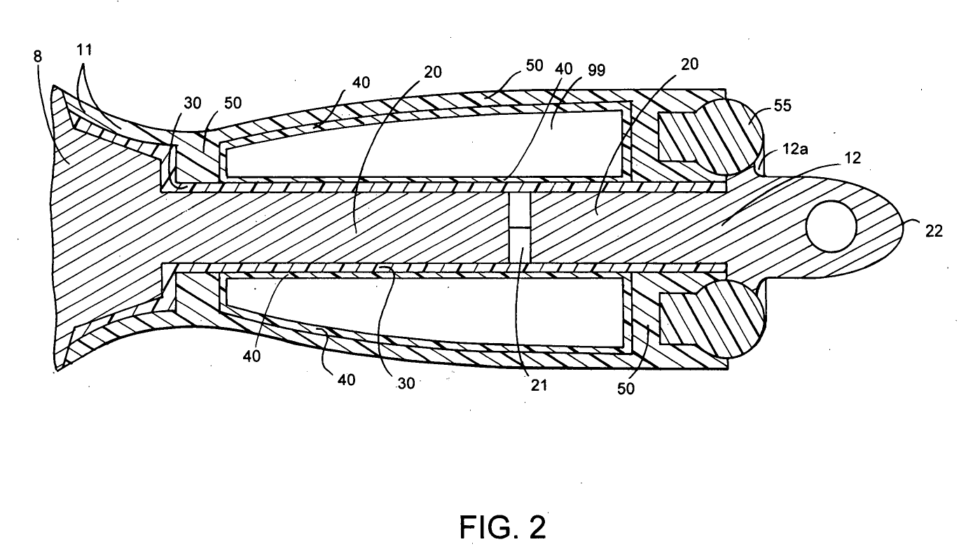

As seen from FIGS. 1-2, a comfortable yet firm handle 10 for kitchen implements is presented for incorporation into kitchen implements of the kind that have a handle and an active tool component. By “active tool component” is meant simply the portion of the implement that actively participates in and is in contact with the object that the implement is designed to affect. For example, as seen in FIG. 1, the active tool component 8 of a peeler 5 would be the peeler section at the end of a peeler. The active tool component of an egg scrambler would be the scrambling part beyond the handle at one end of the egg scrambler. Basically, anything that performs an active culinary function on the food would be the typical example of the active tool component 8.

Handle 10 of implement 5 comprises an inner core 20 made of a rigid substance such as metal, plastic or wood. Inner core 20, in a preferred embodiment at least, is composed of two separate pieces of the same material with an air pocket 21 between them, as best appreciated from FIG. 2. The air pocket 21 is for assembly purposes and it is a made of plastic injected with air. The air pocket and the hard plastic or metal inner core are placed inside the mold when the handle 10 is made. During the molding process soft plastic is added around the inner core 20 and air pocket 21 and this process seals the inner core 20 to the air pocket 21.

Handle 10 has a head 11 or first end 11 proximal to the active tool component 8 and handle 10 also has a tail 12 or second end 12 distal from active tool component 8. In a preferred embodiment, head 11 is made of metal or hard plastic.

Inner core 20 has at a second end 12 of the handle 10 a hang end 22 for hanging the implement 5. As described more fully below, hand end 22 overlaps the second end 12 of the handle 10 with a curved edge of extra material to ensure a clean connection without a gap and thereby eliminate the possible buildup of grease and food. In a preferred embodiment, hang end 22 is made of the same material as head 11 (the first end 11 of handle 10 described more fully below) which is metal or plastic.

Directly surrounding the inner core 20 is a hard plastic sleeve 30 made of hard plastic. In a preferred embodiment, the hard plastic is polypropylene. Surrounding the sleeve 30 and spanning roughly 60 to 80 percent of the length of handle 10 is tubular air cushion 40 covering all 360 rotational degrees around the handle 10. As a result of the length of the air cushion 40 and its shape and as a result of the nature and thickness of the material surrounding air cushion 40, a person holding handle 10 can “feel” the air cushion 40 along 60 to 80 percent of the length of handle 10, which compared to prior art handles, is a very large amount of air cushion capable of being felt by someone holding the handle.

Inside the air cushion 40 is pressurized air 99 rather than the atmospheric air used in prior art cushioned handles. The pressurized air is injected into the air cushion by a well known process during manufacturing the handle. The 360 degrees of coverage assures that there are no hard spots in the grip of the handle. In handle, a firm and even pressure is achieved from the use of pressurized air inside the tubular air cushion 40.

It is noted that the cross-sectional shape chosen for the preferred embodiment of the present invention has advantages. The circular cross-section is the ideal engineering structure from the point of view of stability. There are no joints that appear in a any object that has a cross-section having a shape other than a circle, for example a square. The handle is therefore very durable. The circular cross-section also meets the requirements of the user of the handle since it provides a uniform distribution of pressure around the entire surface of the handle 10. That is, from whatever side of the handle the user pushes in or squeezes, whether the user squeezes with a non-uniformly applied force or not, the force of the user's squeeze tends to be opposed by an equal force pushing against it. This is not true of handles with non-circular cross-sections.

Handle 10 also includes end ring 55 for adding strength to the second end 12 of handle 10 and additionally for decorative purposes.

Importantly, handle 10 also includes a solid overmold filler 50 made of polyurethane. The polyurethane filler 50 occupies the outer layer of the handle adjacent the user's hand and the area between the hard plastic sleeve 30 and the air cushion 40. Thus the filler 50 occupies most of the remaining internal volume of the handle 10, although it does not occupy the area of the end ring 55 and the area of the hang end 22. Polyurethane, as the material making up the filler 50 in the handle 10 of the present invention, has been found to be more durable than rubber or other materials. This durability is characterized in particular by the fact that after repeated squeezings of the handle by the user, if the handle has polyurethane as its filler then the handle retains its firmness over an extended period of time and its ability to bounce back to its original shape does not decrease after a lengthy amount of use of the handle. In contrast, other materials such as silicone or rubber used in the filler of the handle of the kind used in the present invention do not achieve that durability. Rather, over time, after a significant quantity of squeezings by the user of the handle, the handle starts to become softer and softer. Its firmness deteriorates. Its elastic quality deteriorates. The polyurethane does not deteriorate in this way like other materials. The softness of the handle does not increase over time.

Surprisingly, moreover, based on test of various material including polyurethane, polyurethane has been found to be more resistant to dust and dirt on the surface of the handle than other materials such as silicone or ppr rubber. In addition, polyurethane works better with the natural and chemical adhesives that connect the polyurethane to the other parts of the handle 10.

The polyurethane filler 50 occupies the outer layer of the handle adjacent the user's hand in a manner that allows the user to feel the air cushion 40 below it. Polyurethane filler 50 is sufficiently thin and soft to accomplish this.

Handle 10 also contains an end ring 55 at a second end 12 of handle 10 which is the end that is distal to the active tool component, as best seen in FIG. 2. The end ring 55 strengthens the structural integrity of the second end 12 of handle 10. In a preferred embodiment, the same end of handle 10 containing the end ring 55 also has a hang end 22 that attaches to the inner core 20 and to end ring 55. The hang end 22 contains an aperture or other hanging structure that permits easily hanging the entire handle implement 5 with handle 10 on a peg or on another kitchen accessory on the kitchen wall or on a kitchen cabinet. In order for the hang end 22 to best attach to the inner core and end ring 55, hang end 22 is in a preferred embodiment made of hard plastic or metal although in an alternative embodiment hang end 22 can be made of any suitable rigid material.

Handle 10 has been assembled in a manner that drastically reduces the possible buildup of grease or food on the handle 10. In particular, the assembly of the handle 10 has been carried out in a manner that there is overlap of the connecting parts of the handle 10. For example, there is overlap of the handle 10 with the active tool component 8 or tool 8. The head 11 or first end 11 of handle 10 is connected to the active tool component 8 of the implement 5 so that the surface of the first end is flush with and forms an overlapping connection with the surface of the active component 8. This means that the active tool component 8 fits over the first end 12 of the handle 10 (or vice versa in an alternative embodiment) with a “brim” or extra piece that conceals the connection point.

Likewise, there is overlap at the second end 12 of handle 10 between the handle 10 (minus the hang end 22) and the hang end 22 wherein in a preferred embodiment, the hang end 22 overlaps with second end 12 of handle 10. Extra piece of material 12a conceals the connection point between the hang end 22 and the handle 10. In an alternative embodiment, the overlap is from the handle (minus the hang end) which has an extra piece to the hang end.

This overlap minimizes the presence of any gaps between parts which drastically reduces the possible buildup of grease or food. In addition, although there is overlap between connecting parts, the connection with the parts of the handle 10 has been constructed so that the handle 10 is flush with the hang end 22 and with the active tool component 8—this means that there is no space between the parts and the parts hug one another so that the surfaces of the respective parts do not have a bump at the connection point between the head 11 and the active tool component 8 and between the handle 10 (minus the hang end 22) and the hang end 22. This makes it easier to clean the handle.

As can be seen from FIGS. 1-2, the outer shape of handle 10 is tapered along its length. In one preferred embodiment, the approximate ratio of the diameter of handle 10 at its widest part adjacent end ring 55 to the diameter of handle 10 at its narrowest point at the other end of handle 10 just beyond air cushion 40, ranges from approximately 7 to 5 to approximately 5 to 3. For example, in one preferred embodiment, the diameter at the larger end of handle 10 is 40 millimeters and at the smaller end 26 millimeters. In a second preferred embodiment, the largest and smallest diameters are 35 and 26 millimeters respectively, in a third embodiment 36 and 25 millimeters respectively and in a fourth preferred embodiment 32 and 25 millimeters respectively. Notwithstanding these examples it should be clearly understood that the present invention is by no means limited to handles of this dimension or ratio. Furthermore, in general, the present invention is not limited to particular dimensions, unless explicitly stated in the claims.

It should be understood that the cushioned handle of the present invention can be incorporated into a wide variety of kitchen implements and that the size of the implements is not relevant to exploitation of the present invention. Thus, a wide variety of sizes, such as lengths and widths, may be used in accordance with the present invention. Furthermore, in order to be within the scope of the present invention, it is not at all necessary for the relative thicknesses of the layers of the materials of the present invention, or other dimensions, to be limited to those shown in the particular embodiments illustrated in the drawings.

It is to be understood that while the apparatus of this invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof. It is not desired to limit the invention to the exact construction and operation shown and described. The spirit and scope of this invention are limited only by the spirit and scope of the following claims.

What is claimed is:

1. A comfortable yet firm handle for kitchen implements, said kitchen implements of the kind that have a handle and an active tool component, the handle comprising:
an inner core made of a rigid substance,
a hard plastic sleeve surrounding the inner core,
an annular air cushion tube surrounding most of the plastic sleeve and housing pressurized air, the air cushion tube spanning approximately 60 to approximately 80 percent of a length of the handle, the tube spanning a full 360 rotational degrees of the handle,
a solid polyurethane filler forming an outer layer of the handle, said solid polyurethane filler filling a remainder of the handle in a manner that approximately 60 to approximately 80 percent of the air cushion tube can be felt by a person holding the handle,
the handle distributing pressure from a squeezing grip of a user uniformly throughout the handle,
a first end of the handle connected to the active tool component of the implement so that a surface of the first end is flush with and forms an overlapping connection with a surface of the active component.

2. The handle of claim 1, including an end ring at a second end of the handle distal from the active tool component.

3. The handle of claim 2, wherein a hang end surrounding the end ring has an aperture for hanging the handle.

4. The handle of claim 3, wherein the air cushion tube is made of polyvinyl chloride

5. The handle of claim 1, wherein the inner core is made of two pieces having an air pocket between them.

6. The handle of claim 1, including an end ring at a second end of the handle distal from the active tool component and wherein a hang end surrounding the end ring has an aperture for hanging the handle.

7. A comfortable yet firm kitchen implement, comprising:
(i) an active tool component,
(ii) a handle comprising:
an inner core made of a rigid substance,
a hard plastic sleeve surrounding the inner core,
an annular air cushion tube surrounding most of the plastic sleeve and housing pressurized air, the air cushion tube spanning approximately 60 to approximately 80 percent of a length of the handle, the tube spanning a full 360 rotational degrees of the handle,
a solid polyurethane filler forming an outer layer of the handle, said solid polyurethane filler filling a remainder of the handle in a manner that approximately 60 to approximately 80 percent of the air cushion tube can be felt by a person holding the handle,
the handle distributing pressure from a squeezing grip of a user uniformly throughout the handle,
a first end of the handle connected to the active tool component so that a surface of the first end is flush with and forms an overlapping connection with a surface of the active component.

8. The handle of claim 7, including an end ring at a second end of the handle distal from the active tool component.

9. The handle of claim 8, wherein a hang end surrounding the end ring has an aperture for hanging the handle.

10. The handle of claim 9, wherein the air cushion tube is made of polyvinyl chloride

11. The handle of claim 7, wherein the inner core is made of two pieces having an air pocket between them.

12. The handle of claim 7, including an end ring at a second end of the handle distal from the active tool component and wherein a hang end surrounding the end ring has an aperture for hanging the handle.
